(19) United States
(12) Patent Application Publication
(10) Pub. No.: US 2026/0125106 A1
(43) Pub. Date: May 7, 2026

(54) STEERING CONTROL SYSTEM AND METHOD FOR AUTONOMOUS VEHICLE

(71) Applicants: Hyundai Motor Company, Seoul (KR); Kia Corporation, Seoul (KR)

(72) Inventor: Byung Woo CHAE, Hwaseong-Si (KR)

(21) Appl. No.: 19/304,095

(22) Filed: Aug. 19, 2025

(30) Foreign Application Priority Data
Nov. 1, 2024 (KR) 10-2024-0153639

(51) Int. Cl. B62D 6/00; B62D 15/02

(52) U.S. Cl. CPC B62D 6/001; B62D 15/0215

(57) ABSTRACT

An apparatus of a vehicle may comprise a steering angle sensor configured to output a sensing signal associated with an angle of a steering wheel of the vehicle, a first processor configured to determine, based on the sensing signal and at least two different logics, respective first steering wheel angles of the vehicle, and based on the respective first steering wheel angles of the vehicle being consistent with each other, output a first signal indicating a first steering wheel angle of the vehicle, and a control circuit configured to control, based on the first signal, operation of the vehicle.

### CROSS-REFERENCE TO RELATED APPLICATION

This application claims the benefit of priority to Korean Patent Application No. 10-2024-0153639 filed in the Korean Intellectual Property Office on November 1, 2024, the entire contents of which are incorporated herein by reference.

### TECHNICAL FIELD

Examples of the present disclosure relate to a steering control system and method for a vehicle.

BACKGROUND The matters described in this Background section are only for enhancement of understanding of the background of the disclosure, and should not be taken as acknowledgment that they correspond to prior art already known to those skilled in the art.

A steering system applied to a vehicle may include a steering angle sensor that is installed on a steering shaft to transmit a steering force in conjunction with a steering wheel operated by a driver and detects a rotation angle of the steering wheel, i.e., a steering angle. The steering angle, which is basic information for vehicle operation, may be used for providing various functions such as an autonomous driving system and a driver assistance system.

Therefore, in the event of an error related to a function of calculating and transmitting a steering angle, some or all the functions, including an autonomous driving function, that use a steering angle signal of a steering wheel may be affected (e.g., disabled).

### SUMMARY

Examples of the present disclosure aim to provide a vehicle steering control system and a control method thereof, which may reduce the probability of an error in a steering wheel angle value and recover itself in the event of such an error, thereby maintaining normal vehicle functions including an autonomous driving function without an emergency stop.

The technical challenges to be solved by the examples of the present disclosure are not limited to the technical challenges described above, and other technical challenges not described above will also be clearly understood by one of ordinary skill in the art to which the present disclosure pertains from the following description.

According to the present disclosure, an apparatus of a vehicle, the apparatus may comprise a steering angle sensor configured to output a sensing signal associated with an angle of a steering wheel of the vehicle, a first processor configured to, determine, based on the sensing signal and at least two different logics, respective first steering wheel angles of the vehicle, and based on the respective first steering wheel angles of the vehicle being consistent with each other, output a first signal indicating a first steering wheel angle of the vehicle, and a control circuit configured to control, based on the first signal, operation of the vehicle.

The apparatus may further comprise a second processor configured to, determine, based on the sensing signal and the at least two different logics, respective second steering wheel angles, and based on the respective second steering wheel angles being consistent with each other, output a second signal indicating a second steering wheel angle, wherein the control circuit is further configured to control, based on at least one of the first signal and the second signal, autonomous driving operation of the vehicle.

The apparatus, wherein the first processor is configured to output a first error signal based on the respective first steering wheel angles being inconsistent with each other, wherein the second processor is configured to output a second error signal based on the respective second steering wheel angles being inconsistent with each other, and wherein the control circuit is further configured to control operation of the vehicle based on a steering wheel angle output received from one processor that is not outputting a corresponding error signal.

The apparatus, wherein the other processor is configured to perform a recovery process to recover from an error state using the steering wheel angle output from the one processor that is not outputting the corresponding error signal.

The apparatus, wherein the steering angle sensor may comprise a main gear connected to a steering shaft, a first sub-gear having fewer teeth than the main gear and rotating in engagement with the main gear, a second sub-gear having fewer teeth than the first sub-gear and rotating in engagement with the main gear, a first sensor configured to output a first sensing signal according to a rotation of the first sub-gear, and a second sensor configured to output a second sensing signal according to a rotation of the second sub-gear.

The apparatus, wherein the first processor and the second processor are each configured to, determine, based on the first sensing signal and the second sensing signal, a first rotation angle of the first sub-gear and a second rotation angle of the second sub-gear, and determine a plurality of rotation angles of the main gear, wherein the plurality of rotation angles of the main gear is determined based on the at least two different logics, the first rotation angle, and the second rotation angle.

The apparatus, wherein the at least two different logics comprise a first logic configured to output a first-logic steering wheel angle based on a rotation angle of the main gear associated with the first logic, wherein the rotation angle of the main gear associated with the first logic is determined based on the first rotation angle and the second rotation angle, and a second logic configured to output a second-logic steering wheel angle based on a rotation angle of the main gear associated with the second logic, wherein the rotation angle of the main gear associated with the second logic is determined based on an accumulated change in a rotation angle of the main gear over time.

The apparatus, wherein the first processor and the second processor are each configured to, determine an error state and output an error signal based on respective steering wheel angles determined using the at least two different logics being inconsistent with each other, based on a determination of the error state, receive a steering wheel angle output from the other processor in which a corresponding error state does not occur, initialize computation using one of the at least two different logics based on the received steering wheel angle output from the other processor, and recalculate a steering wheel angle.

According to the present disclosure, a method performed by an apparatus of a vehicle, the method may comprise receiving, by a first processor of the apparatus, a sensing signal associated with an angle of a steering wheel of the vehicle, based on a first logic and the sensing signal, determining, by the first processor, a steering wheel angle associated with the first logic, based on a second logic and the sensing signal, determining, by the first processor, a steering wheel angle associated with the second logic, based on the two steering wheel angles determined by the first processor being consistent with each other, outputting, by the first processor, a first signal indicating a first steering wheel angle, and controlling, based on the first signal, operation of the vehicle.

The method may further comprise receiving, by a second processor of the apparatus, the sensing signal, based on the first logic and the sensing signal, determining, by the second processor, a second steering wheel angle associated with the first logic, based on the second logic and the sensing signal, determining, by the second processor, a second steering wheel angle associated with the second logic, based on the two second steering wheel angles determined by the second processor being consistent with each other, outputting, by the second processor, a second signal indicating a second steering wheel angle, and controlling, based on at least one of the first signal or the second signal, autonomous driving operation of the vehicle.

The method may further comprise determining, by at least one of the first processor or the second processor, an error state, wherein the error state determined by the first processor is based on the two steering wheel angles determined by the first processor being inconsistent with each other, and wherein the error state determined by the second processor is based on the two second steering wheel angles being inconsistent with each other, and outputting an error signal indicating the error state.

The method may further comprise performing, by one processor in which a corresponding error state occurs, a recovery process to recover from the corresponding error state by using a steering wheel angle received from the other processor in which a corresponding error state does not occur.

The method, wherein the performing of the recovery process may comprise comparing the steering wheel angle received from the other processor to the two steering wheel angles determined by the one processor in the corresponding error state, and recomputing a steering wheel angle by initializing one or more computational parameters of either the first logic or the second logic based on the received steering wheel angle.

According to the present disclosure, an apparatus of a vehicle, the apparatus may comprise a first processor, and a first memory storing at least one first instruction that, when executed by the first processor communicating with the first memory, is configured to cause the apparatus to, obtain, from a sensor of the apparatus, a sensing signal related to a steering operation of the vehicle, determine, based on the sensing signal and a first logic, a first steering angle of the vehicle, determine, based on the sensing signal and a second logic different from the first logic, a second steering angle of the vehicle, compare the first steering angle and the second steering angle, output a signal indicating a result of the comparison of the first steering angle and the second steering angle, and control, based on the signal, operation of the vehicle.

The apparatus may further comprise a second processor, and a second memory storing at least one second instruction that, when executed by the second processor communicating with the second memory, is configured to cause the apparatus to, obtain the sensing signal from the sensor, determine, based on the first logic and the second logic, a steering angle of the vehicle, and transmit the steering angle of the vehicle to the first processor, wherein the at least one first instruction, when executed by the first processor, is further configured to cause the apparatus to, based on determining an inconsistency between the first steering angle and the second steering angle, initialize steering angle computation based on the steering angle received from the second processor.

The apparatus may further comprise a steering angle sensor configured to output the sensing signal, wherein the first steering angle is further based on a combination of rotation angles of a first sub-gear and a second sub-gear that are engaged with a main gear connected to a steering shaft.

The apparatus may further comprise a steering angle sensor configured to output the sensing signal, wherein the second steering angle is further based on a change in rotation angle of the main gear accumulated over time from an initial reference angle.

The apparatus, wherein the at least one first instruction, when executed by the first processor, is further configured to cause the apparatus to compare the first steering angle and the second steering angle by determining whether a difference between the first steering angle and the second steering angle falls within a predefined consistency threshold.

The apparatus, wherein the at least one second instruction, when executed by the second processor, is further configured to cause the apparatus to, determine a third steering angle and a fourth steering angle using the first logic and the second logic, respectively, and compare the third steering angle and the fourth steering angle to detect an inconsistency.

The apparatus, wherein the at least one first instruction, when executed by the first processor, is further configured to cause the apparatus to, compare the steering angle received from the second processor to each of the first steering angle and the second steering angle, and based on the comparison of the steering angle received from the second processor to each of the first steering angle and the second steering angle, cause initialization of one of the first logic or the second logic using the steering angle received from the second processor as an initial value.

The technical challenges to be solved by the examples of the present disclosure are not limited to the technical challenges described above, and other technical challenges not described above will also be clearly understood by one of ordinary skill in the art to which the present disclosure pertains from the following description.

### BRIEF DESCRIPTION OF THE DRAWINGS

FIG. 1 shows an example configuration of a steering angle sensor device applied to a steering control system for a vehicle according to one example of the present disclosure.

FIG. 2 shows an example of a steering control system for a vehicle according to one example of the present disclosure.

FIG. 3 shows an example of a first logic for determining a steering wheel angle.

FIG. 4 shows an example of a second logic for determining a steering wheel angle.

FIG. 5 shows an example of operations of a steering control system for a vehicle according to one example of the present disclosure.

### DETAILED DESCRIPTION

Hereinafter, examples of the present disclosure will be described in detail with reference to the accompanying drawings. The examples are not construed as limited to the disclosure and should be understood to include all changes, equivalents, and replacements within the idea and the technical scope of the disclosure. In describing the examples disclosed herein, detailed descriptions of related known art are omitted where it is deemed that such detailed description would obscure the essence of the examples disclosed herein. Further, the accompanying drawings are intended to facilitate an understanding of the examples disclosed herein, and the technical ideas disclosed herein are not limited by the accompanying drawings.

Throughout the specification, like reference numerals refer to like components. The specification does not describe all elements or components of the examples, and omits those that are common in the art to which this disclosure pertains or that are redundant among the examples. The terms "module," "unit," and/or "-er/or" for referring to elements are assigned and used interchangeably in consideration of the ease of explanation, and thus the terms per se do not necessarily have different meanings or functions. The terms "module," "unit," and/or "-er/or" do not necessarily require physical separation.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

Although terms including ordinal numbers, such as, "first," "second," and the like, may be used herein to describe various elements, the elements are not limited by these terms. These terms are only used to distinguish one element from another.

When an element is described as "coupled" or "connected" to another element, the element may be directly coupled or connected to the other element. However, it is to be understood that another element may be present therebetween. In contrast, when an element is described as "directly coupled" or "directly connected" to another element, it is to be understood that there are no other elements therebetween.

The singular forms "a," "an," and "the" are intended to include the plural forms as well, unless the context clearly indicates otherwise.

It is to be further understood that the terms "comprises/comprising" and/or "includes/including" used herein specify the presence of stated features, integers, steps, operations, elements, and/or components, but do not preclude the presence or addition of one or more other features, integers, steps, operations, elements, components and/or groups thereof.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

A fault-tolerant steering angle calculation system is introduced. The system includes at least two processors, each processor using at least two different logics to detect internal inconsistencies. The redundancy across processors may enable recovery, thereby providing robustness against software miscalculations and/or hardware errors associated with the processors.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of redundant dual-logic steering angle determination with cross-MCU error recovery) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of redundant dual-logic steering angle determination with cross-MCU error recovery) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of redundant dual-logic steering angle determination with cross-MCU error recovery) described herein.

Minimum risk maneuver (MRM) operation(s) may also be controlled, for example, based on one or more features (e.g., features of redundant dual-logic steering angle determination with cross-MCU error recovery) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of redundant dual-logic steering angle determination with cross-MCU error recovery) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of redundant dual-logic steering angle determination with cross-MCU error recovery) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

A steering control system for a vehicle and a control method thereof, according to examples of the present disclosure, may reduce the probability of an error in a steering wheel angle by dualizing the computational logic of a microcontroller unit (MCU) that computes a steering wheel angle and outputting, as a steering wheel angle, a value calculated when steering wheel angles calculated according to different computational logics are consistent with each other. In addition, by dualizing the MCU, two or more MCUs may independently output respective steering wheel angles. Thus, even in the event of an error in one of the MCUs, vehicle functions including an autonomous driving function may be maintained using a steering wheel angle of another one of the MCUs. On the other hand, in an MCU where an error occurs due to an inconsistency between the calculated steering wheel angles, the MCU may recover itself from such an error state by receiving a steering wheel angle output from another MCU and recovering a computation result of a logic where the error has occurred. Therefore, it is possible to minimize a situation where the functions of the vehicle are interrupted due to an MCU error.

Hereinafter, examples disclosed herein will be described in detail with reference to the accompanying drawings.

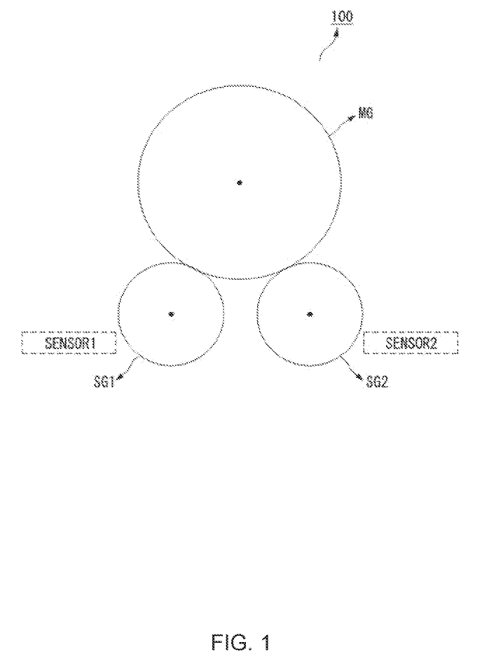

FIG. 1 shows an example configuration of a steering angle sensor device 100 applied to a steering control system for a vehicle according to one example of the present disclosure. The configuration may be applicable to various types of vehicles (e.g., electric vehicles, autonomous shuttles, delivery robots, or industrial AGVs, etc.)

Referring to FIG. 1, the steering angle sensor device 100 may include a main gear (MG) mounted on a steering shaft, a first sub-gear (SG1) and a second sub-gear (SG2) each having a certain gear ratio with respect to the main gear MG, and a first sensor (SENSOR1) and a second sensor (SENSOR2), which are respectively configured to sense rotation angles of the first sub-gear SG1 and the second sub-gear SG2, respectively. These sensors may include magnetic, optical, or Hall effect sensors, etc.

The main gear MG may be installed on the steering shaft that transmits operation force of a steering wheel, and may rotate in conjunction with a rotation of the steering wheel. Thus, an angle of the main gear MG may be the same as a steering wheel angle, and the steering wheel angle or, alternatively, the angle of the main gear MG, may be considered a steering angle of the vehicle. Such correspondence between the gear and the wheel angle may be used in driver-assist systems, lane-keeping systems, or autonomous driving functions, etc.

The first sub-gear SG1 and the second sub-gear SG2 may have fewer teeth than the main gear MG and may rotate in engagement with the main gear MG. The first sub-gear SG1 and the second sub-gear SG2 may be formed with respective numbers of teeth that differ from each other and from the main gear MG. Accordingly, when the main gear MG rotates once, the first sub-gear SG1 and the second sub-gear SG2 may rotate a plurality of times. For example, the rotation speed of the main gear MG and the rotation speed of the first sub-gear SG1 and the second sub-gear SG2 may be different, for example, due to the gear ratios. Since the rotation ratios of the main gear MG, the first sub-gear SG1, and the second sub-gear SG2 are set by the number of teeth, the rotation angle of the main gear MG may be calculated by combining the rotation angles of the first sub-gear SG1 and the second sub-gear SG2. This principle may be implemented using gear ratio encoding or harmonic feedback logic, for example.

The first sensor SENSOR1 may output a first sensing signal according to a rotation of the first sub-gear SG1, and the second sensor SENSOR2 may output a second sensing signal according to a rotation of the second sub-gear SG2. The sensing signals may be used to generate sin and cos waveforms for angular estimation using an arctangent function, or for digital encoding of the sub-gear position, etc.

This configuration may allow the steering angle sensor device 100 to output, when the steering shaft rotates, the first sensing signal according to the rotation of the first sub-gear SG1 and the second sensing signal according to the rotation of the second sub-gear SG2. These signals may be used for real-time steering angle computation in various control systems (e.g., electric power steering, lane-keeping assistance, autonomous driving modules, or stability control, etc.)

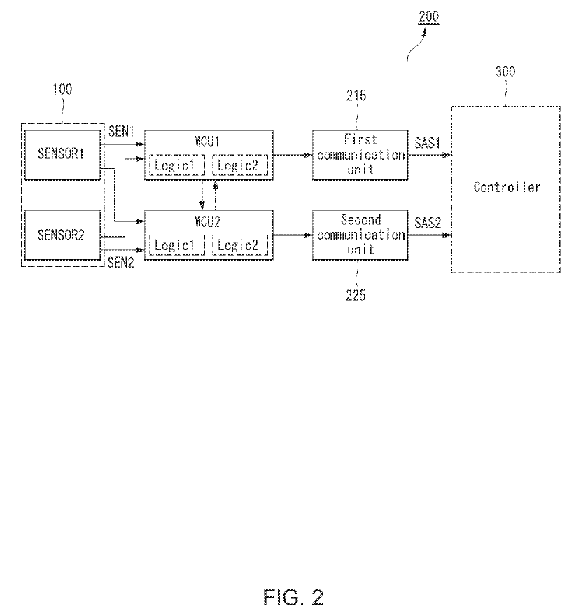

FIG. 2 shows an example of a steering control system for a vehicle according to one example of the present disclosure. The configuration shown may be implemented in centralized or distributed electronic control architectures, depending on the application.

Referring to FIG. 2, a steering control system 200 for a vehicle, according to one example of the present disclosure, may include a steering angle sensor device 100, a first computing unit MCU1 (e.g., a first processor or circuit), a second computing unit MCU2 (e.g., a second processor circuit), a first communication unit 215 (e.g., first transceiver, first circuitry, etc.), a second communication unit 225 (e.g., second transceiver, second circuitry, etc.), and a controller 300 (e.g., a processor, application specific integrated circuits (ASICs), microcontrollers, system-on-chip devices, etc.). Herein the first computing unit MCU1 may include one or more first processors, possibly in combination with a memory, to execute the functionality of the first computing unit MCU1, and also the second computing unit MCU2 may include one or more second processors, possibly in combination with a memory, to execute the functionality of the second computing unit MCU2.

The steering angle sensor device 100 may include a first sensor SENSOR1 and a second sensor SENSOR2, as described above with reference to FIG. 1. The first sensor SENSOR1 may output a first sensing signal (SEN1) according to a rotation of the first sub-gear SG1, using, for example, a magnetic, optical, or capacitive angle sensing method, etc. The second sensor SENSOR2 may output a second sensing signal (SEN2) based on a rotation of the second sub-gear SG2, using, for example, a sine/cosine encoder, Hall effect sensor, or optical rotary encoder, etc. The first sensor SENSOR1 and the second sensor SENSOR2 may each be an angle sensor configured to output a sensing signal in the form of a sine signal (sin.) or a cosine signal (cos.) according to the rotation of the respective sub-gear SG1 and second sub-gear SG2. Such sensors may include magneto-resistive sensors, capacitive encoders, or optical rotary encoders, etc., depending on system requirements.

The first computing unit MCU1 may compute (or calculate) a steering wheel angle by receiving the first sensing signal SEN1 and the second sensing signal SEN2, which may originate from sensors using magnetic, optical, or capacitive detection techniques, etc. In this case, the first computing unit MCU1 may include at least two logics (e.g., Logic1 and Logic2) for computing the steering wheel angle, such as an absolute angle calculation based on gear positions and a delta-based tracking logic using accumulated angular changes, etc. The logics (e.g., Logic1 and Logic2) for computing a steering wheel angle are described in detail below. The first computing unit MCU1 may calculate the steering wheel angle by computationally processing the first sensing signal SEN1 and the second sensing signal SEN2 according to the at least two logics Logic1 and Logic2, each of which may apply different models (e.g., arctangent computation, differential integration, or lookup-based correction, etc.). In this case, when computation results from the respective logics Logic1 and Logic2 are consistent with each other, the first computing unit MCU1 may output the corresponding steering wheel angle as a computation result, which may then be used for downstream vehicle control functions (e.g., steering assist, lane keeping, or autonomous path tracking, etc.). However, when the steering wheel angle computed according to the first logic Logic1 and the steering wheel angle computed according to the second logic Logic2 are different or inconsistent, the first computing unit MCU1 may determine an error state and output an error signal. Such processing may be implemented through redundancy-based computation frameworks (e.g., majority voting, plausibility checking, or sensor fusion validation, etc.).

The first communication unit 215 may transmit, to the controller 300, a steering wheel angle SAS1 or the error signal output from the first computing unit MCU1. The first communication unit 215 may include a communication module that supports a communication interface with vehicle controllers connected via a vehicle network, such as a Controller Area Network (CAN), Local Interconnect Network (LIN), FlexRay, or automotive Ethernet, etc. In this case, the communication module may include a module that supports, for example, controller area network (CAN) communication, Local Interconnect Network (LIN), FlexRay, or Ethernet communication, etc.

The second computing unit MCU2 may perform the same functions as the first computing unit MCU1. For example, the second computing unit MCU2 may receive the first sensing signal SEN1 and the second sensing signal SEN2 in the same way as the first computing unit MCU1, and may compute a steering wheel angle using logics (e.g., Logic1 and Logic2) in the same way as the first computing unit MCU1, thereby enabling redundant and independent validation of the computed angle (e.g., for fault detection, cross-verification, or failover processing, etc.). In this case, when the computation results from the respective logics Logic1 and Logic2 are consistent with each other, the second computing unit MCU2 may also output the corresponding steering wheel angle as a valid computation result, similar to the first computing unit MCU1. However, when the steering wheel angle computed according to the first logic Logic1 and the steering wheel angle computed according to the second logic Logic2 are inconsistent , the second computing unit MCU2 may determine an error state and output an error signal. This duplication of logic in both computing circuits may improve system reliability in safety-critical applications (e.g., Level 4 autonomous driving, steer-by-wire systems, or emergency parking maneuvers, etc.).

The second communication unit 225 may transmit, to the controller 300, either a steering wheel angle SAS2 or an error signal output from the second computing unit MCU2. The second communication unit 225 may include a module that supports the same communication method as the first communication unit 215, such as, for example, CAN communication, FlexRay, or automotive Ethernet communication.

In the steering control system 200 for a vehicle according to one example of the present disclosure, the first computing unit MCU1 and the second computing unit MCU2 may be configured to communicate with each other. The first computing unit MCU1and the second computing unit MCU2 may transmit and receive their respective calculated steering wheel angles and error signals to/from each other via a connection circuit for transmitting and receiving signals between the MCUs. The communication between the first computing unit MCU1 and the second computing unit MCU2 may be performed at a certain interval, or may be performed when an event such as an error state occurs. Such inter-processor communication may use a dedicated serial line, a high-speed in-vehicle bus, or a memory-mapped interface, etc.

When the steering wheel angles calculated according to the first logic Logic1 and the second logic Logic2, respectively, are the same, the first computing unit MCU1 and the second computing unit MCU2 may each output that same steering wheel angle as a valid result. When the steering wheel angles are different or inconsistent, they may output an error signal. In case of an error, it may be difficult for an MCU itself to determine which of the computations of the first logic Logic1 or the second logic Logic2 is in error. Accordingly, the MCU may recover such an error state by receiving a steering wheel angle from an MCU in a normal state (e.g., an error free state). For example, between the computation results of the first logic Logic1 and the second logic Logic2, a value equal to the steering wheel angle received from the MCU in the normal state may be set as an initial value, and the subsequent computation may then proceed based on that initial value. Then, when the steering wheel angle computation results of the first logic Logic1 and the second logic Logic2 are the same, the MCU may then switch to the normal state and output a steering angle as a valid result. As described above, the MCU in which an error occurs may recover the error state by itself by outputting an error signal, setting an initial computation value based on the steering wheel angle received from the MCU in the normal state (e.g., an error free state), and then recalculating the steering wheel angle. Such recovery may occur within a short window (e.g., 10–50 milliseconds) to ensure continued autonomous control without interruption.

The controller 300 may include control units of systems that perform control based on the steering wheel angle signal, such as, for example, an autonomous driving system, a steering control system, a lane-keeping assist system, a parking assist system, or a stability control system, etc. The controller 300 may control functions associated with driving of the vehicle, such as, for example, controlling an autonomous driving assistance function, executing lane-centering, coordinating with braking or speed control, or controlling a steering angle (e.g., adjusting the steering angle for path tracking), based on the steering wheel angles (e.g., SAS1 and SAS2) input via the first communication unit 215 and the second communication unit 225. When the error signal is received from one of the first computing unit MCU1 and the second computing unit MCU2, the controller 300 may maintain an autonomous driving control state or an emergency driving state based on the steering wheel angle received from the MCU where an error does not occur (e.g., remains in the normal state). Then, when the MCU is recovered from the error within a predetermined reference time, the controller 300 may maintain an autonomous driving control mode, and even if the error is not recovered, the related functions may still be maintained by receiving the steering wheel angle from the MCU in the normal state. This may allow fault-tolerant operation in scenarios such as temporary sensor glitches, logic divergence, or processor timing faults, etc.

As described above, the steering control system 200 for a vehicle, according to one example of the present disclosure, may implement dual computation logics for each of the first computing unit MCU1 and the second computing unit MCU2 to calculate a steering wheel angle and may compute the steering wheel angle according to two or more logics (e.g., Logic1 and Logic2), and only when the respective computation results of the logics Logic1 and Logic2 are consistent with each other, may the steering control system 200 then output a corresponding steering wheel angle, as a computation result. This may significantly reduce the probability of an error in the computation result. In addition, by duplicating an MCU configured to output a steering wheel angle, the first computing unit MCU1 and the second computing unit MCU2 may output the steering wheel angles via the first communication unit 215 and the second communication unit 225, respectively. Thus, even if an error occurs in one of the MCUs, the steering wheel angle may be received from the other MCU in a normal state, and related functions such as autonomous driving may be provided. Further, by providing a signal transmission and reception function between the MCUs, the MCU in which an error has occurred may receive a steering wheel angle from the other MCU in the normal state and may thereby recover itself from such an error state. This configuration may enhance functional safety in applications requiring redundancy and fault tolerance, such as SAE Level 4 or Level 5 autonomous vehicles.

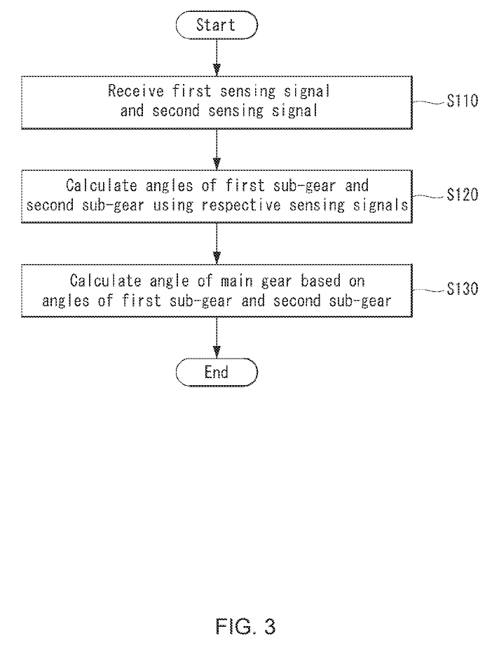

FIG. 3 shows an example of a first logic for determining a steering wheel angle. A method by which an MCU calculates a steering wheel angle according to a first logic Logic1 is described in detail with reference to FIGS. 1 through 3. This logic may serve as the primary baseline angle computation method in normal operating conditions.

The MCU may receive a first sensing signal SEN1 and a second sensing signal SEN2 from the steering angle sensor device 100 in step S110. The first sensing signal SEN1 and the second sensing signal SEN2 may be acquired in the form of a sine signal (sin.) and a cosine signal (cos.), respectively. These signals may originate from angle sensors attached to sub-gears SG1 and SG2, which provide analog or digital output for high-resolution angle estimation.

When calculating the steering wheel angle according to the first logic Logic1, an angle of the first sub-gear SG1 may be determined based on the first sensing signal SEN1, and an angle of the second sub-gear SG2 may be determined based on the second sensing signal SEN2 in step S120. When the first sensing signal SEN1 and the second sensing signal SEN2 are sensed in the form of a sine signal (sin.) and a cosine signal (cos.), respectively, the angles of the first sub-gear SG1 and the second sub-gear SG2 may be calculated using an arctangent function (e.g., arctan2) to determine an angular displacement.

Based on the angles of the first sub-gear SG1 and the second sub-gear SG2, an angle of the main gear MG may be determined in step S130. In this case, the rotation angles of the first sub-gear SG1 and the second sub-gear SG2 may be derived from a rotation angle of the main gear MG. Therefore, by combining the angles of the first sub-gear SG1 and the second sub-gear SG2, a number of rotations of the main gear MG may be determined, and the rotation angle of the main gear MG may be determined with respect to a preset point. In this case, the angle of the main gear MG may be the same as the steering wheel angle, and the steering wheel angle or the angle of the main gear MG may be considered to be the steering angle of the vehicle. This angle determination approach may enable tracking of the steering wheel’s absolute position, not just its position within a single turn (e.g., position tracking even across multiple turns of the steering wheel).

As described above, the first logic Logic1 may be a logic for calculating an angle (absolute angle) of the main gear MG with respect to a reference position by combining the rotation angles of the first sub-gear SG1 and the second sub-gear SG2. For example, such logic may be used as a baseline computation method during system initialization or calibration.

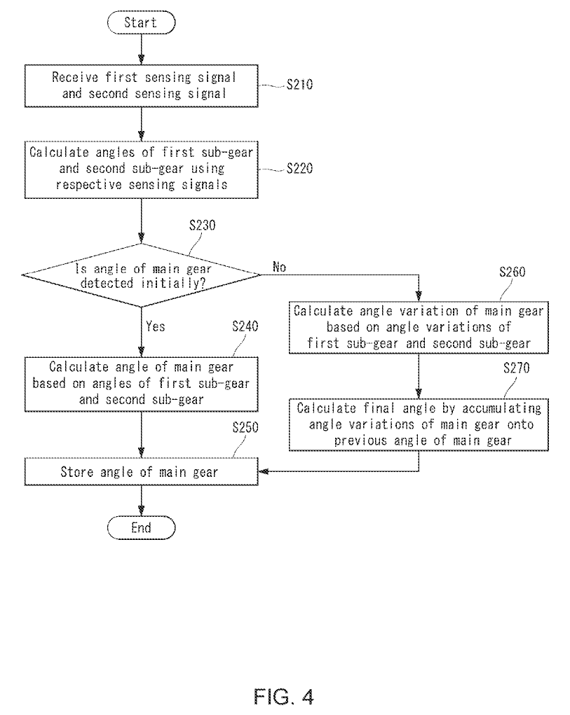

FIG. 4 shows an example of a second logic for determining a steering wheel angle. A method by which an MCU calculates a steering wheel angle according to a second logic Logic2 is described in detail with reference to FIGS. 1, 2, and 4. This second logic may enable dynamic tracking of angular change from a known starting position.

The MCU may receive a first sensing signal SEN1 and a second sensing signal SEN2 from the steering angle sensor device 100 in step S210. The first sensing signal SEN1 and the second sensing signal SEN2 may be acquired in the form of a sine signal (sin.) and a cosine signal (cos.), respectively. These analog signals may be sampled and digitized by an ADC circuit before computation.

An angle of the first sub-gear SG1 may be calculated from the first sensing signal SEN1, and an angle of the second sub-gear SG2 may be calculated from the second sensing signal SEN2, in step S220. The angle values may then be used to track incremental changes in gear rotation over time.

The MCU may check whether an angle of the main gear MG has been initially determined in step S230 and, if it is, may determine an angle of the main gear MG based on the angles of the first sub-gear SG1 and the second sub-gear SG2 in step S230. For example, when the angle of the main gear MG has been initially determined, the angle of the main gear MG may be determined using the same method as the first logic Logic1.

Subsequently, the MCU may store the determined angle of the main gear MG in step S250, and may proceed to step S210 of receiving the first sensing signal SEN1 and the second sensing signal SEN2.

When it is checked in step S230 that the angle of the main gear MG has already been determined, the MCU may determine a variation in the angle of the main gear MG based on a variation in the angle of the first sub-gear SG1 and a variation in the angle of the second sub-gear SG2 in step S260.

The MCU may determine the angle of the main gear MG by accumulating the determined variation in the angle of the main gear MG onto a previously stored angle of the main gear MG, in step S270.

Subsequently, the MCU may store the determined angle of the main gear MG in step S250 and may return to step S210 of receiving the first sensing signal SEN1 and the second sensing signal SEN2.

As described above, in an initial determination, the second logic Logic2 may determine an angle of the main gear MG with respect to a reference position by combining the rotation angles of the first sub-gear SG1 and the second sub-gear SG2, and may then determine the rotation angle of the main gear MG by accumulating a variation in the angle of the main gear MG based on the variation in the angle of the first sub-gear SG1 and the variation in the angle of the second sub-gear SG2. This may allow the system to dynamically track steering wheel movement beyond a single turn, ensuring continuous angular tracking.

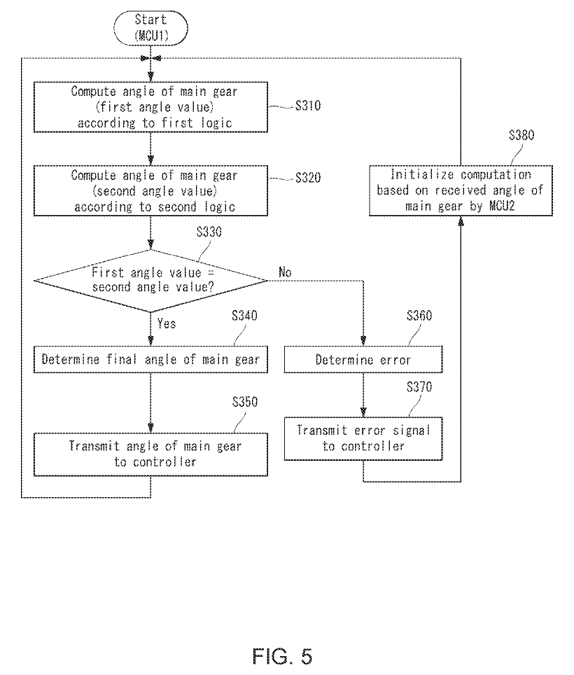

FIG. 5 shows an example of operations of a steering control system for a vehicle according to one example of the present disclosure. Although a control flow of the first computing unit MCU1 is illustrated, the steering control system for a vehicle according to one example of the present disclosure has a dualized MCU structure, and thus the same control flow of the first computing unit MCU1 may be equally applicable to the second computing unit MCU2.

The first computing unit MCU1 may acquire a first angle value by determining an angle of the main gear MG based on the first logic Logic1 in step S310.

The first computing unit MCU1 may also acquire a second angle value by calculating an angle of the main gear MG based on the second logic Logic2 in step S320.

The first computing unit MCU1 may determine whether the calculated first angle value and the calculated second angle value are consistent with each other in step S330. This comparison may involve checking whether the difference between the two values falls within a predefined tolerance.

When the first angle value and the second angle value are consistent, the first computing unit MCU1 may determine either of the consistent angle values as a final angle of the main gear MG in step S340.

The first computing unit MCU1 may transmit the final angle of the main gear MG to the controller 300 via the first communication unit 215 in step S350. Based on the angle of the main gear MG (e.g., the steering wheel angle SAS1), the controller 300 may then control functions related to driving the vehicle, such as, for example, controlling an autonomous driving assistance function, controlling a steering angle, initiating lane-keeping assistance, or modulating steering torque, and the like.

When the first angle value according to the first logic Logic1 and the second angle value according to the second logic Logic2 are inconsistent with each other as a result of the determining in step S330, the first computing unit MCU1 may determine an error state in step S360. This inconsistency may indicate a fault in the angle computation or signal degradation.

In the error state, the first computing unit MCU1 may transmit an error signal to the controller 300 via the first communication unit 215 in step S370. The controller may then initiate fallback measures based on redundancy or partial operation.

The first computing unit MCU1 may then receive the angle of the main gear MG (e.g., the steering wheel angle SAS2) from the second computing unit MCU2, which is in a normal state, to recover itself from the error state in step S380, thereby enabling continued operation of steering-related functions without interruption (e.g., during autonomous driving, adaptive steering, or trajectory correction, etc.). In this case, the first computing unit MCU1 may set an initial value to match the angle of the main gear MG (e.g., the steering wheel angle SAS2) received from the second computing unit MCU2, in place of one of the first angle value and the second angle value. Subsequently, the first computing unit MCU1 may perform step S310 to start recalculation. During the recalculation, when the first angle value according to the first logic Logic1 and the second angle value according to the second logic Logic2 are consistent with each other, the error state may be recovered, for example, allowing the system to resume normal operation without triggering emergency fallback behavior (e.g., steering lockout, degraded control, or autonomous mode suspension, etc.).

For example, in a case where a steering wheel angle calculation period is 10 milliseconds (ms), and the error is recovered within a certain preset period (e.g., within 50 ms), the autonomous vehicle may continue to maintain the autonomous driving function. This rapid recovery capability may help prevent unnecessary fallback to emergency driving states or unnecessary interruptions to the autonomous driving function.

According to one example of the present disclosure, a steering control system for a vehicle may include a steering angle sensor device configured to output a sensing signal according to an angle of a steering wheel of the vehicle, and a first processor configured to output a first steering wheel angle when steering wheel angles determined by at least two logics are consistent with each other.

The steering control system may further include a second processor configured to output a second steering wheel angle when steering wheel angles determined by the at least two logics are consistent with each other, and a controller configured to control the vehicle based on the first or second steering wheel angle.

The first processor and the second processor may be each configured to output an error signal based on a determination of an error state when the steering wheel angles are inconsistent with each other. The controller may be configured to control the vehicle based on a steering wheel angle output from one of the first and second processors which does not output the error signal.

The other of the first processor and the second processor may be configured to recover from the error state by use of the steering wheel angle output from the one unit.

The steering angle sensor device may include: a main gear connected to a steering shaft; a first sub-gear having fewer teeth than the main gear and rotating in engagement with the main gear; a second sub-gear having fewer teeth than the first sub-gear and rotating in engagement with the main gear; a first sensor configured to output a first sensing signal according to a rotation of the first sub-gear; and a second sensor configured to output a second sensing signal according to a rotation of the second sub-gear.

The first processor and the second processor may be each configured to calculate, based on the first sensing signal and the second sensing signal, a first rotation angle of the first sub-gear and a second rotation angle of the second sub-gear, and calculate rotation angles of the main gear according to the at least two logics based on the first rotation angle and the second rotation angle.

The at least two logics may include a first logic that outputs a first-logic steering wheel angle based on a rotation angle of the main gear determined based on the first rotation angle and the second rotation angle and a second logic that outputs a second-logic steering wheel angle based on a rotation angle of the main gear determined based on an accumulated change in the rotation angle of the main gear.

The first processor and the second processor may be each configured to determine an error state and output an error signal when the first-logic and second-logic steering wheel angles are inconsistent with each other, when it is determined that the error state occurs, receive a steering wheel angle output from the other processor in which the error state does not occur initialize computation for one of the first-logic and second-logic steering wheel angles by use of the other one which is determined based on the received steering wheel angle and then recalculate a steering wheel angle.

According to another example of the present disclosure, a method of controlling a steering control system for a vehicle may include receiving, by a first processor, a sensing signal , calculating, by the first processor, a first-logic steering wheel angle based on the sensing signal according to a first logic, calculating, by the first processor, a second-logic steering wheel angle based on the sensing signal according to a second logic, and when the first-logic steering wheel angle and the second-logic steering wheel angle are consistent with each other, outputting, by the first processor, a first steering wheel angle.

The method may further include receiving, by a second processor, the sensing signal, computing a first-logic steering wheel angle according to the first logic and a second-logic steering wheel angle according to the second logic, and outputting a second steering wheel angle, and controlling, by a controller, the vehicle based on at least one of the first second steering wheel angles.

The method may further include determining, by each of the first processor and the second processor, an error state and outputting an error signal when the first-logic steering wheel angle and the second-logic steering wheel angle are inconsistent with each other, and controlling, by the controller, the vehicle based on the first or second steering wheel angle.

The method may further include by one unit, of the first processor and the second processor, in which the error state occurs, recovering from the error state by use of the steering wheel angle received from the other unit in which the error state does not occur.

The recovering of the steering wheel angle computation result may include comparing the steering wheel angle received from the other processor in which the error state does not occur to the first-logic steering wheel angle and the second-logic steering wheel angle and re-computing a steering wheel angle by setting computational parameters for one, of the first-logic steering wheel angle and the second-logic steering wheel angle, which is determined based on the received steering wheel angle, as one or more initial values for computational parameters for the other.

Examples of the present disclosure have the following effects.

The vehicle steering control system and the control method thereof, according to the examples of the present disclosure, may reduce the probability of an error in a steering wheel angle by calculating a steering wheel angle according to different computation logics in a single microcontroller unit (MCU) and outputting a corresponding value as the steering wheel angle when computation results are consistent with each other.

The vehicle steering control system and the control method thereof, according to the examples of the present disclosure, may maintain vehicle functions including an autonomous driving function using a steering wheel angle calculated by MCUs in a normal state, as two or more MCUs independently output steering wheel angles even in the event of an error occurring in one of MCUs. In addition, if an error occurs due to an inconsistency between steering wheel angles calculated in the MCUs, an MCU in such an error state may be recovered by itself using a steering wheel angle output from another MCU to recover a computation result of a logic in which the error has occurred. Thus, a situation where a driving function is interrupted due to an MCU error may be prevented or minimized.

While preferred examples of the present disclosure have been shown and described above, the present disclosure is not limited to the specific examples described above, various changes and modifications may be made by one of ordinary skill in the art to which the present disclosure pertains without departing from the spirit and scope of the disclosure, and such changes and modifications should not be construed as being independent of the technical ideas or views of the present disclosure.

What is claimed is:

1. An apparatus of a vehicle, the apparatus comprising:
a steering angle sensor configured to output a sensing signal associated with an angle of a steering wheel of the vehicle;
a first processor configured to:
determine, based on the sensing signal and at least two different logics, respective first steering wheel angles of the vehicle, and
based on the respective first steering wheel angles of the vehicle being consistent with each other, output a first signal indicating a first steering wheel angle of the vehicle; and
a control circuit configured to control, based on the first signal, operation of the vehicle.

2. The apparatus of claim 1, further comprising:
a second processor configured to:
determine, based on the sensing signal and the at least two different logics, respective second steering wheel angles, and
based on the respective second steering wheel angles being consistent with each other, output a second signal indicating a second steering wheel angle, wherein the control circuit is further configured to control, based on at least one of the first signal and the second signal, autonomous driving operation of the vehicle.

3. The apparatus of claim 2, wherein the first processor is configured to output a first error signal based on the respective first steering wheel angles being inconsistent with each other,
wherein the second processor is configured to output a second error signal based on the respective second steering wheel angles being inconsistent with each other, and
wherein the control circuit is further configured to control operation of the vehicle based on a steering wheel angle output received from one processor of the first processor and the second processor that is not outputting a corresponding error signal.

4. The apparatus of claim 3, wherein the other processor of the first processor and the second processor is configured to perform a recovery process to recover from an error state using the steering wheel angle output from the one processor that is not outputting the corresponding error signal.

5. The apparatus of claim 2, wherein the steering angle sensor comprises:
a main gear connected to a steering shaft;
a first sub-gear having fewer teeth than the main gear and rotating in engagement with the main gear;
a second sub-gear having fewer teeth than the first sub-gear and rotating in engagement with the main gear;
a first sensor configured to output a first sensing signal according to a rotation of the first sub-gear; and
a second sensor configured to output a second sensing signal according to a rotation of the second sub-gear.

6. The apparatus of claim 5, wherein the first processor and the second processor are each configured to:
determine, based on the first sensing signal and the second sensing signal, a first rotation angle of the first sub-gear and a second rotation angle of the second sub-gear; and
determine a plurality of rotation angles of the main gear, wherein the plurality of rotation angles of the main gear is determined based on the at least two different logics, the first rotation angle, and the second rotation angle.

7. The apparatus of claim 6, wherein the at least two different logics comprise:
a first logic configured to output a first-logic steering wheel angle based on a rotation angle of the main gear associated with the first logic, wherein the rotation angle of the main gear associated with the first logic is determined based on the first rotation angle and the second rotation angle; and
a second logic configured to output a second-logic steering wheel angle based on a rotation angle of the main gear associated with the second logic, wherein the rotation angle of the main gear associated with the second logic is determined based on an accumulated change in a rotation angle of the main gear over time.

8. The apparatus of claim 7, wherein the first processor and the second processor are each configured to:
determine an error state and output an error signal based on respective steering wheel angles determined using the at least two different logics being inconsistent with each other, based on a determination of the error state, receive a steering wheel angle output from the other processor in which a corresponding error state does not occur;
initialize computation using one of the at least two different logics based on the received steering wheel angle output from the other processor; and
recalculate a steering wheel angle.

9. A method performed by an apparatus of a vehicle, the method comprising:
receiving, by a first processor of the apparatus, a sensing signal associated with an angle of a steering wheel of the vehicle;
based on a first logic and the sensing signal, determining, by the first processor, a steering wheel angle associated with the first logic;
based on a second logic and the sensing signal, determining, by the first processor, a steering wheel angle associated with the second logic;
based on the two steering wheel angles determined by the first processor being consistent with each other, outputting, by the first processor, a first signal indicating a first steering wheel angle; and
controlling, based on the first signal, operation of the vehicle.

10. The method of claim 9, further comprising:
receiving, by a second processor of the apparatus, the sensing signal;
based on the first logic and the sensing signal, determining, by the second processor, a second steering wheel angle associated with the first logic;
based on the second logic and the sensing signal, determining, by the second processor, a second steering wheel angle associated with the second logic;
based on the two second steering wheel angles determined by the second processor being consistent with each other, outputting, by the second processor, a second signal indicating a second steering wheel angle; and
controlling, based on at least one of the first signal or the second signal, autonomous driving operation of the vehicle.

11. The method of claim 10, further comprising:
determining, by at least one of the first processor or the second processor, an error state, wherein the error state determined by the first processor is based on the two steering wheel angles determined by the first processor being inconsistent with each other, and wherein the error state determined by the second processor is based on the two second steering wheel angles being inconsistent with each other; and
outputting an error signal indicating the error state.

12. The method of claim 11, further comprising:
performing, by one processor of the first processor or the second processor in which a corresponding error state occurs, a recovery process to recover from the corresponding error state by using a steering wheel angle received from the other processor of the first processor or the second processor in which a corresponding error state does not occur.

13. The method of claim 12, wherein the performing of the recovery process comprises:
comparing the steering wheel angle received from the other processor to the two steering wheel angles determined by the one processor in the corresponding error state; and
recomputing a steering wheel angle by initializing one or more computational parameters of either the first logic or the second logic based on the received steering wheel angle.

14. An apparatus of a vehicle, the apparatus comprising:
a first processor; and
a first memory storing at least one first instruction that, when executed by the first processor communicating with the first memory, is configured to cause the apparatus to:
obtain, from a sensor of the apparatus, a sensing signal related to a steering operation of the vehicle;
determine, based on the sensing signal and a first logic, a first steering angle of the vehicle;
determine, based on the sensing signal and a second logic different from the first logic, a second steering angle of the vehicle;
compare the first steering angle and the second steering angle;
output a signal indicating a result of the comparison of the first steering angle and the second steering angle; and
control, based on the signal, operation of the vehicle.

15. The apparatus of claim 14, further comprising:
a second processor; and
a second memory storing at least one second instruction that, when executed by the second processor communicating with the second memory, is configured to cause the apparatus to:
obtain the sensing signal from the sensor,
determine, based on the first logic and the second logic, a steering angle of the vehicle, and
transmit the steering angle of the vehicle to the first processor,
wherein the at least one first instruction, when executed by the first processor, is further configured to cause the apparatus to, based on determining an inconsistency between the first steering angle and the second steering angle, initialize steering angle computation based on the steering angle received from the second processor.

16. The apparatus of claim 14, further comprising a steering angle sensor configured to output the sensing signal, wherein the first steering angle is further based on a combination of rotation angles of a first sub-gear and a second sub-gear that are engaged with a main gear connected to a steering shaft.

17. The apparatus of claim 16, further comprising a steering angle sensor configured to output the sensing signal, wherein the second steering angle is further based on a change in rotation angle of the main gear accumulated over time from an initial reference angle.

18. The apparatus of claim 14, wherein the at least one first instruction, when executed by the first processor, is further configured to cause the apparatus to compare the first steering angle and the second steering angle by determining whether a difference between the first steering angle and the second steering angle falls within a predefined consistency threshold.

19. The apparatus of claim 15, wherein the at least one second instruction, when executed by the second processor, is further configured to cause the apparatus to:
determine a third steering angle and a fourth steering angle using the first logic and the second logic, respectively, and
compare the third steering angle and the fourth steering angle to detect an inconsistency.

20. The apparatus of claim 15, wherein the at least one first instruction, when executed by the first processor, is further configured to cause the apparatus to:
compare the steering angle received from the second processor to each of the first steering angle and the second steering angle, and
based on the comparison of the steering angle received from the second processor to each of the first steering angle and the second steering angle, cause initialization of one of the first logic or the second logic using the steering angle received from the second processor as an initial value.
